(19) United States
(12) Patent Application Publication
(10) Pub. No.: US 2008/0283717 A1
(43) Pub. Date: Nov. 20, 2008

(54) HOLIDAY DECORATION

(76) Inventors: Michael Y. Kim, Anaheim Hills, CA (US); Mark Susko, Plano, TX (US); Ryan Maule, Las Vegas, NV (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/058,553

(22) Filed: Mar. 28, 2008

Related U.S. Application Data
(60) Provisional application No. 60/908,931, filed on Mar. 29, 2007.

(51) Int. Cl. F16M 13/02

(52) U.S. Cl. 248/524

(57) ABSTRACT

Disclosed herein are decorative artificial trees including a base with base supports and a base hub, a central support, a top portion, and outer supports. The outer supports can extend from one or more base supports to the top portion. The base may be collapsible in a variety of different ways depending on the configuration of the base. The outer supports may, or may not, comprise a rigid material such as plastic or aluminum. Lighting components may be attached to the outer supports. Some of the decorative artificial trees disclosed herein may include a central support that is configured to be collapsible, or may include one or more outer supports that are configured to be collapsible. Also disclosed herein are decorative artificial trees including segmented outer supports and segmented base supports.

### RELATED APPLICATIONS AND CLAIM OF PRIORITY

This application is related to, and claims benefit under 35 U.S.C. § 119(e) to, U.S. Provisional Patent Application No. 60/908,931, filed on Mar. 29, 2007 which is incorporated in its entirety by reference herein.

### BACKGROUND OF THE INVENTIONS

1. Field of the Inventions

The disclosed inventions relate generally to decorative devices and particularly to decorative devices with lighting.

2. Description of the Related Art

Holiday decorations are often positioned around homes, stores, and workplaces at particular times during the year. When not in use, the decorations often need to be disassembled and stored. The assembly and disassembly process can be inconvenient and time consuming, and the storage requirements can be burdensome as well. Artificial Christmas trees and related devices can be particularly inconvenient to assemble, disassemble, and store.

### SUMMARY OF THE INVENTIONS

The inventions disclosed herein relate to Christmas tree decorations that, in some embodiments, are much easier to assemble, disassemble, and store. Although the term “Christmas tree” and related terms are used herein to describe certain embodiments of the disclosed inventions, each of the structures, methods, assemblies, and systems disclosed herein can be made with or applied in decorations of many types, including decorations for other holidays or festive occasions that relate to or resemble the embodiments disclosed herein, and should not be limited to traditional Christmas tree applications or structures.

### BRIEF DESCRIPTION OF THE DRAWINGS

FIG. 1 illustrates a holiday or festive decoration in the form of an artificial Christmas tree.

FIG. 2 illustrates an embodiment of the decorations in which there are generally no lighting components supported by the outer supports.

FIG. 3 illustrates an embodiment of the decorations in which the outer supports can be made of a flexible, long, narrow material.

FIG. 4 illustrates an embodiment of the decorations shown in FIG. 1, in a partially disassembled state.

FIG. 5 illustrates an embodiment of the top portion of the decorations shown in FIG. 1.

FIG. 6 illustrates an embodiment of the central support of the decorations shown in FIG. 1.

FIG. 7 illustrates another aspect of a transition between assembled and collapsed states.

FIG. 8 illustrates another embodiment of the central support.

FIG. 9 illustrates an embodiment of a base including a hub.

FIG. 10 illustrates an example of a segmented central support.

FIG. 11 illustrates another embodiment of a Christmas tree.

### DETAILED DESCRIPTION OF THE PREFERRED EMBODIMENT

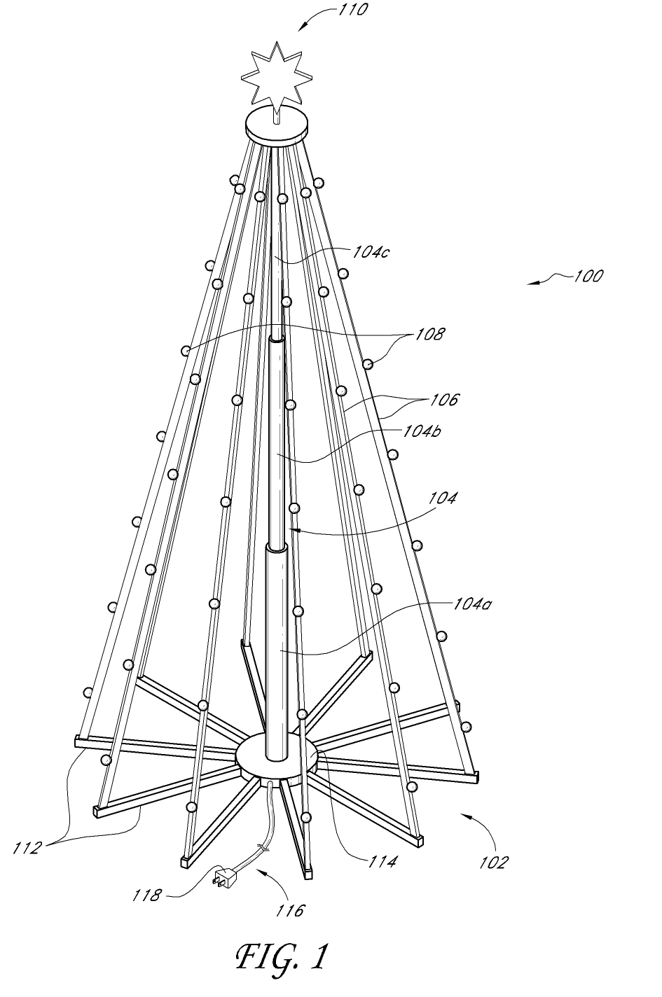

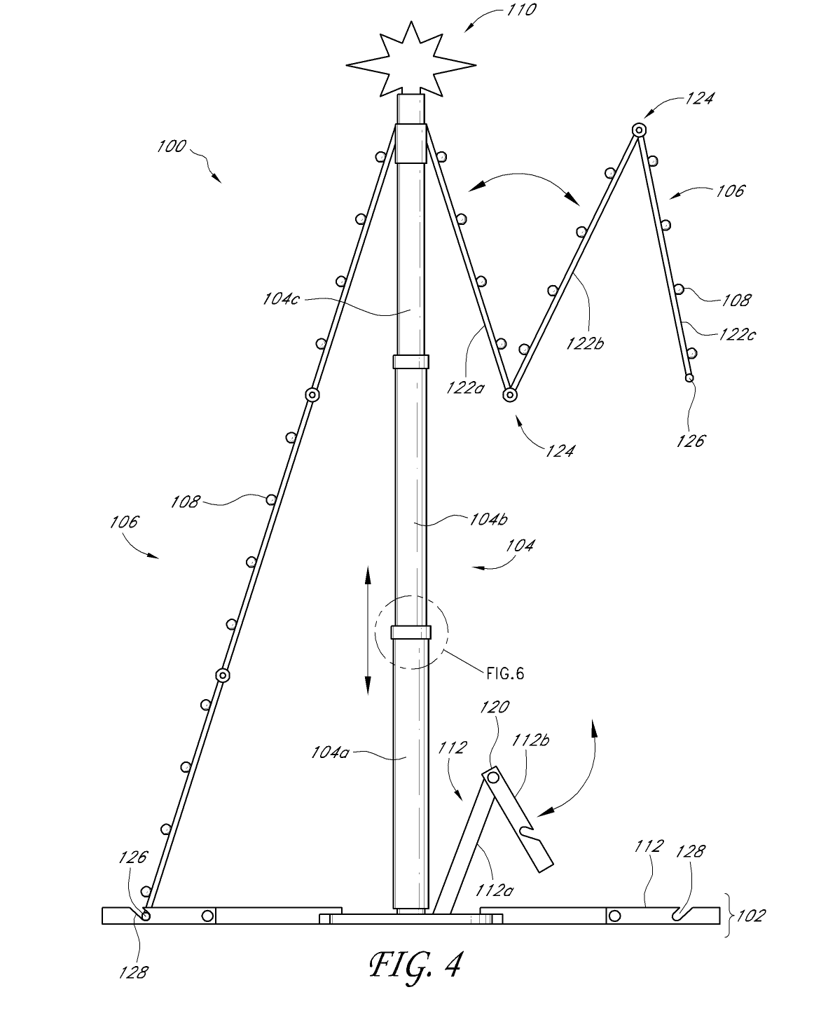

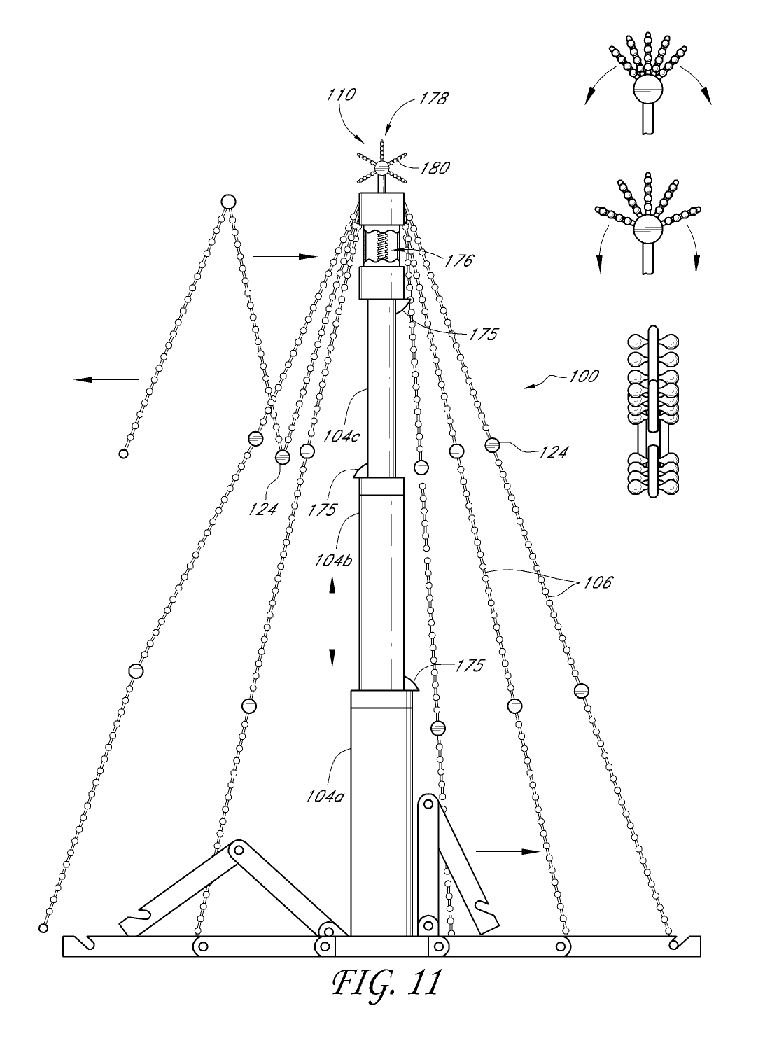

FIG. 1 illustrates a holiday or festive decoration 100 in the form of an artificial Christmas tree with a base 102, a central support 104, a plurality of outer supports 106, a plurality of lighting components 108, and a top portion 110. In the Christmas tree 100, the outer supports 106 comprise a relatively rigid material, such as PVC plastic or aluminum, to support and secure the lighting components 108. Examples of this embodiment are illustrated in more detail in FIGS. 4 and 11. The Christmas tree 100 can be used as an indoor decoration or as an outdoor decoration.

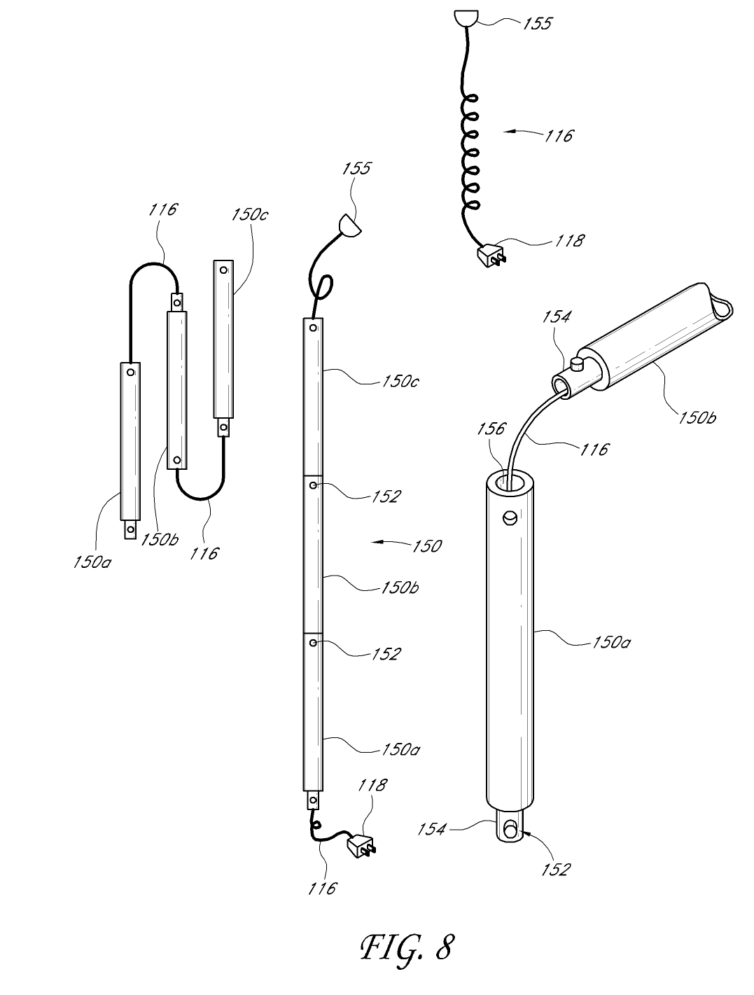

The central support 104 can comprise multiple central support segments 104a, 104b, 104c. In the illustrated embodiment, segment 104c is adapted to retract or nest partially or completely within segment 104b, and segment 104b is in turn adapted to retract or nest partially or completely within segment 104c, for convenient storage, assembly, and disassembly. The segments 104a, 104b, 104c can also be coupled and stored in other ways, such as by screwing together, or with interference fits, snaps, clips, or biased protrusions (described in more detail in connection with the embodiments illustrated in FIGS. 8-10).

The base 102 can comprise a plurality of base supports 112, and a base hub 114. In the illustrated embodiment, there are equal numbers of base supports 112 and outer supports 106 for simplicity of design and to provide structural stability, but different numbers of these components in different configurations can also be used. As shown, each outer support 106 extends from a base support 112 to a position on the top portion 110. In some embodiments, the top portion can be a structure separate from and in addition to the central support, or it may be a portion of the upper part of the central support.

A wire 116 with an outlet connector 118 can be provided near the base hub 114. The wire 116 can be sufficiently long to extend from the Christmas tree 100 to an outlet in a typical household AC electrical system. The wire 116 can also extend within the central support 104 to the top portion, where it can be electrically connected to other wires or other structures (not shown in this figure) to provide electrical current to the lighting components 108 and/or to a lighted portion within the top portion 110.

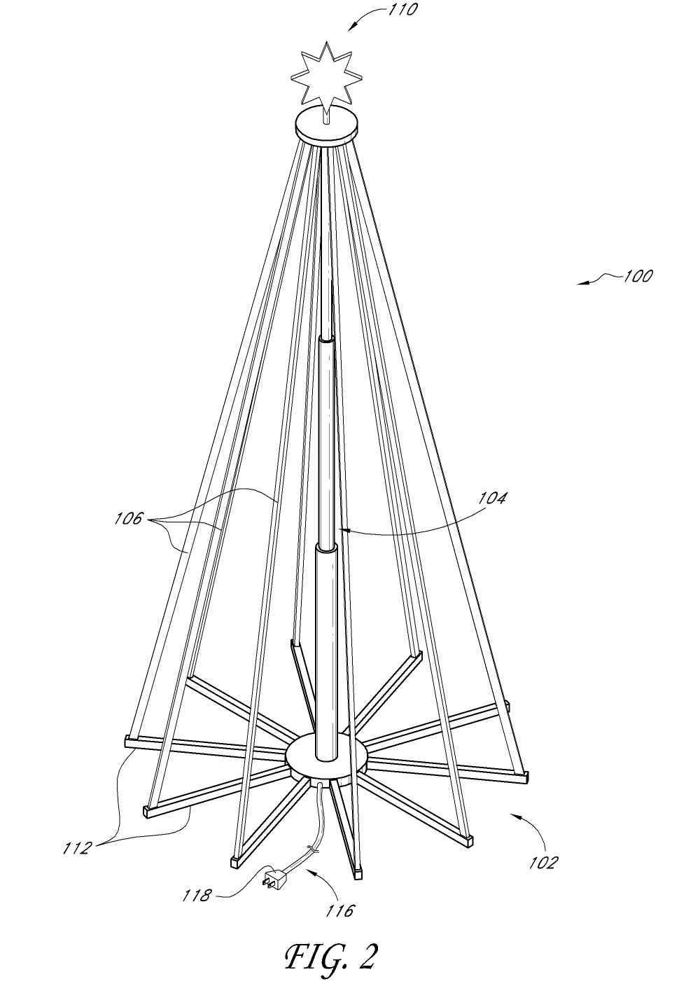

FIG. 2 illustrates another embodiment of a Christmas tree 100. In this embodiment, there are generally no lighting components supported by the outer supports 106. The outer supports 106 are relatively long and narrow, and can be made of such structures as wires, strings, cables, glass fibers, etc., to create an aesthetic appearance. In some embodiments, the outer supports 106 can be made to glow or emit light by internal illumination through conducting light from a source external to the outer supports themselves 106. The electrical wire 116 and electrical outlet connector 118 (if these components are included) can extend through the central support 104 to the top portion 110 to illuminate the top portion 110 and/or other lighting components used to illuminate the supports 106.

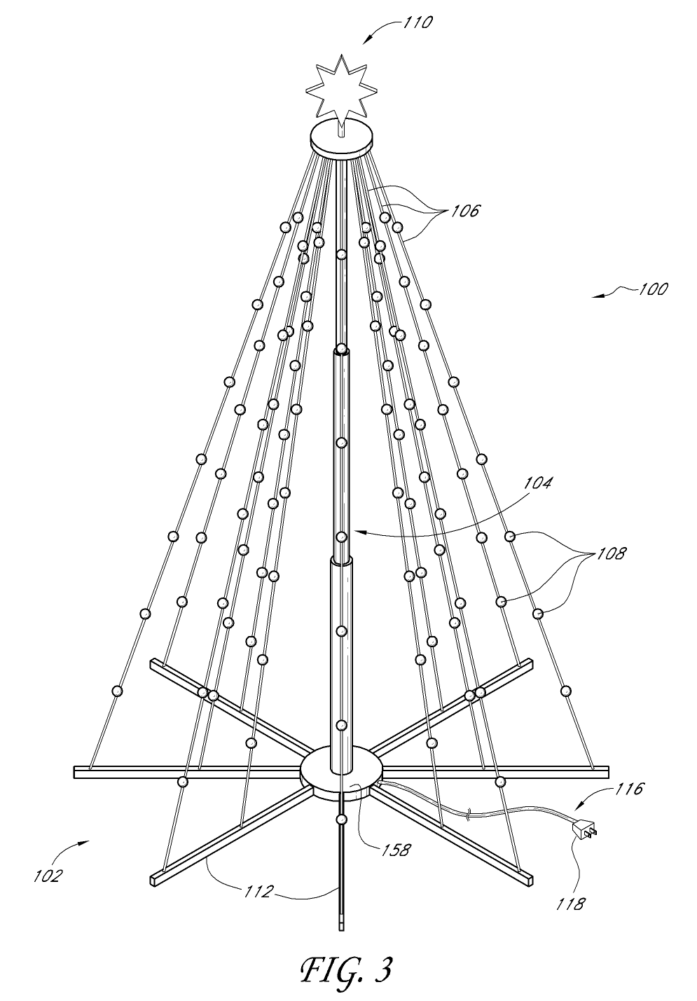

FIG. 3 illustrates another embodiment of the present inventions. In this embodiment, the Christmas tree 100 has outer supports 106 that can be made of a flexible, long, narrow material such as an electrical wire with insulation. The outer supports 106 can support, secure, and provide electrical power to lighting components 108. As shown, a plurality of outer supports 106 can be attached to each base support 112. Once again, the electrical wire 116 and electrical outlet connector 118 can be attached and oriented in an appropriate way to supply power to the top portion 110 and to the lighting components 108.

In the description that follows, various examples, structures, materials, concepts, and descriptions will be provided. Each of these can be applicable, with appropriate modifications as necessary, to the embodiments of FIGS. 1-3, and other embodiments comprising combinations of these, or other structures, and should not be limited to merely those structures that are expressly illustrated or described.

FIG. 4 illustrates an embodiment of the Christmas tree 100 shown in FIG. 1. In this example, the left side of the Christmas tree 100 is shown in an assembled configuration (as in FIG. 1) and the right side of the Christmas tree 100 is shown in a partially disassembled configuration.

The central support 104 can be dissembled by allowing the central support segments 104a, 104b, 104c to rotate with respect to each other. As previously described, this permits the segments to be released from each other and then partially or completely to be nested within each other. Many other ways of assembling and disassembling these segments can also be used, some of which are described and/or shown herein. The base 102 has base supports 112 that include first and second segments 112a, 112b that can fold together when not in use for convenient storage. A joint 120 is provided between these segments 112a, 112b to vary the angle between the segments 112a, 112b to decrease the overall footprint of the base 102. In some embodiments, the angle between the components 112a, 112b can be varied from substantially zero, in a fully extended position, to above 90 degrees, or even nearly 180 degrees, in a compacted or collapsed position. The manner of moving or collapsing the base segments 112a, 112b can be accomplished in many different ways with different materials and joints.

In some embodiments, the central support is made of a lightweight, rigid metal such as aluminum. Other materials may also be used, such as PVC plastic. The central support 104 can have many different lengths, depending on the desired height of the Christmas tree 100. In some embodiments, the central support 104 is less than about 1 foot in length (generally used for a smaller table-top or desk-top versions of the Christmas tree 100). In other embodiments, the central support 104 is at least about 1 foot in length, and can be between about 1 foot and about 3 feet, or between about 3 feet and about 6 feet, or between about 6 feet and about 8 feet, or between about 8 feet and about 12 feet, or greater than about 12 feet.

During the transition from the disassembled (or compacted) state to the assembled (or expanded) state, the base support segments 112a, 112b can be moved by swiveling the joints 120 so that the respective longitudinal axes of these components can form an angle that is substantially less than 90 degrees. As illustrated, on the left side of the Christmas tree in FIG. 4, the base support segments 112a, 112b are in an approximately collinear state. The fully extended base support 112 can be positioned on a flat surface, such as the floor or ground. Although two base support segments 112a, 112b have been illustrated for each base support 112 in FIG. 4, and ten base supports 112 have been illustrated in the base 102 in FIG. 1, many different configurations are possible. For example, each base support 112 can comprise less or fewer base support segments 112a, 112b, and the base 102 can comprise less or fewer base supports 112. In some embodiments, the base can comprise at least three base supports 112. In some embodiments, the base supports 112 are unitary and can fold up against the central support 104 using a hinge-type connection to the central support 104, but the base supports 112 do not include the collapsing segments as illustrated in FIG. 4.

During the transition from the disassembled to the assembled state, the outer supports 106 also can be unfolded and each outer support 106 can be extended from one end at a position at or near the top of the central support 104 to another end at a position on a corresponding base support 112. The outer supports 106 can be made of multiple outer support segments 122a, 122b, 122c, that fold up near each other for convenient storage when not in use, in a manner similar to the base support segments 112a, 112b of the base supports 112. The outer supports 106 can include joints 124 to facilitate the folding of the outer supports 106 by permitting the outer support segments 122a, 122b, 122c to vary the angle between these segments to form a more compact structure.

As shown, an end 126 of the outer supports 106 can be brought into contact with a hook-like structure, or other connecting mechanism 128, on the corresponding base support 112 to achieve a removable connection between the outer components 106 and the base supports 112. Many other types of connectors, structures, and methods can be used to extend a plurality of outer supports 106 from a region at or near the top end of the Christmas tree 100 to a region at or near the bottom end of the Christmas tree 100.

The top portion 110 can be removable or unitary with the central support 104. Thus, the top portion 110 may be a structure separate from and in addition to the central support 104, or it may make up a portion of the upper part of the central support 104. The outer supports 106 can be connected to the top portion 110, and thus the outer supports 106 can be connected to the top portion 110 of the central support 104 or directly to a separate top portion 110. The outer supports 106 can be made of aluminum or PVC plastic, or some other suitable material.

The outer supports 106 can be structured in many different ways. For example, in some embodiments, the outer supports 106 can have a U-shaped cross-section forming a trough or channel. A solid or perforated wall of the U-shaped channel can face outwardly toward those who are viewing the Christmas tree 100. A hollow channel within the U-shaped outer support 106 can face inwardly toward the central support 104. The lighting components 108 can be mounted in or on the surface of the U-shaped channel that faces outwardly, and the wires (not shown) connecting the lighting components 108 can be mounted behind or within the outwardly facing surface of the U-shaped channel. These internal wires can be placed in electrical communication with the wires and connectors illustrated in FIGS. 1-3. The outer supports 106 can have many other shapes and configurations, such as substantially or entirely closed tubes, strips, etc.

The lighting components 108 can comprise many different structures and can be made in many different ways. For example, the lighting components 108 can be LED lights, incandescent bulbs, fluorescent bulbs, fiber optic emission points, or any other suitable lighting components 108.

If the Christmas tree 100 is intended to be used outdoors, there is some risk that it may tip over, especially in extreme weather conditions. To minimize this risk, U-shaped clips, stakes, or other structures of various types can be provided to pass over at least a portion of one or more of the base supports 112 and forced into the ground or grass on which the Christmas tree is positioned. A lighting component (not shown) positioned adjacent to or within the top portion 110 can be made of the same or different types of lighting components as the lighting components 108.

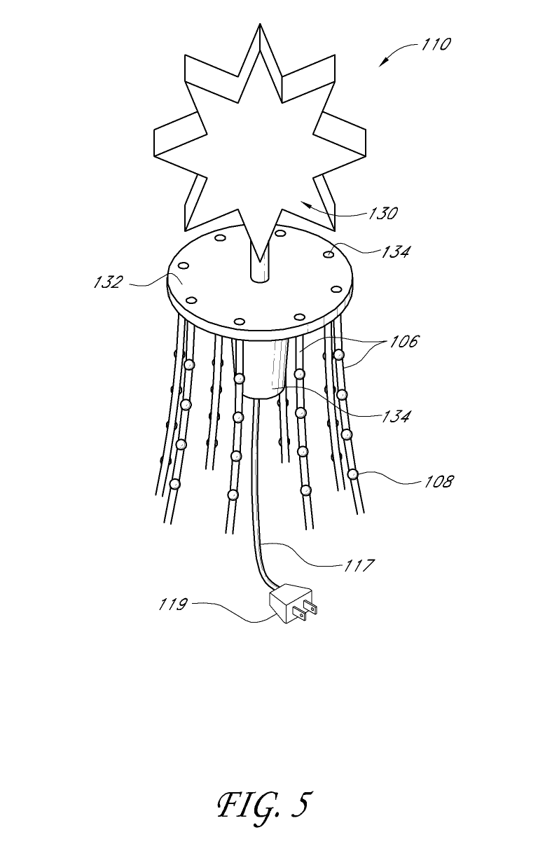

FIG. 5 illustrates an embodiment of a top portion of the Christmas tree 100. The top portion 110 can comprise a decoration 130, in this case a star, a base 132, a connection structure 134, an electrical wire 117, and a electrical connector 119. The top portion 110 can be connected directly to the outer supports 106. The decoration 130 can comprise a material that allows light to pass through it, and a lighting component (not shown) within it can produce light to illuminate the decoration 130. The electrical power for such internal lighting can be provided by the electrical wire 117 and the electrical connector 119. The electrical power can also be provided in other ways such as through the central support 104 to which the top portion 110 is attached. The base 132, of the top portion 110, provides a support for the decoration 130 and allows the decoration 130 to be positioned on the central support 104 in a stable manner. The base 132 can, in some embodiments, extend into or around a top portion of the central support 104 to provide a more secure and/or more stable connection to the central support 104. In the illustrated embodiment, the outer supports 106 comprise wires, but rigid tubes or channels can also be used to comprise the outer supports 106 and thus support the lighting components 108. The outer supports, whether comprises of wires, rigid tubes, or channels, or other suitable materials, 106, or other components, can be connected to the base 132 through bores 134 or other connection structures 134 and can be permanently or removably attached. One of many alternative structures or complimentary structures for a top portion 110 is illustrated in FIG. 11, described in further detail below.

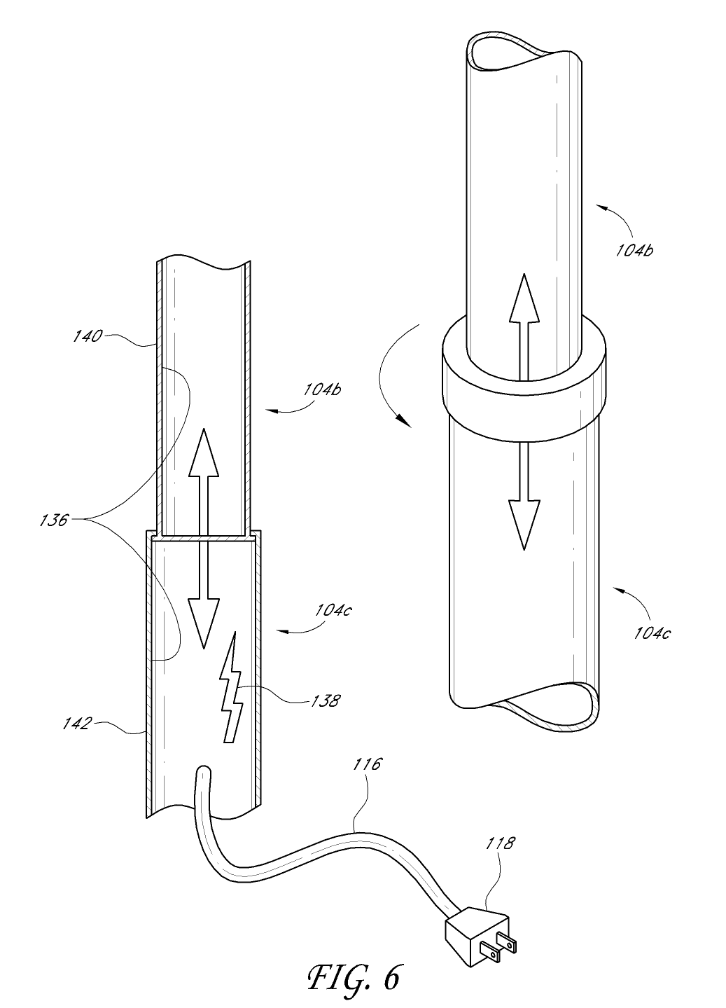

FIG. 6 illustrates a portion of the central support 104. In this embodiment, electrical current can be transferred through the wall of the central support 104 without requiring a wire to transmit the current between the wire 116 and the various lighting components 108 of the Christmas tree 100. In this configuration, electricity is permitted to move along the inner wall 136 of the central support segment 104c. The inner wall 136 is made of a conductive material. An outer surface 140, 142 of the central support segments 104b, 104c can be formed of an insulator, such as rubber, or a rubber-like material, to prevent the electrical current 138 traveling on the interior wall 136 to be transferred elsewhere on the central support 104, or to a person who is touching the central support 104. In this manner, the central support segments 104a, 104b, 104c can be rotated to achieve telescoping or collapsing without tangling or twisting a wire on the inside of the central support 104. The scope of this disclosure includes and encompasses any method of transferring electrical current from the base 102 to the various lighting components 108 used in the Christmas tree 100, and should not be limited to this structure.

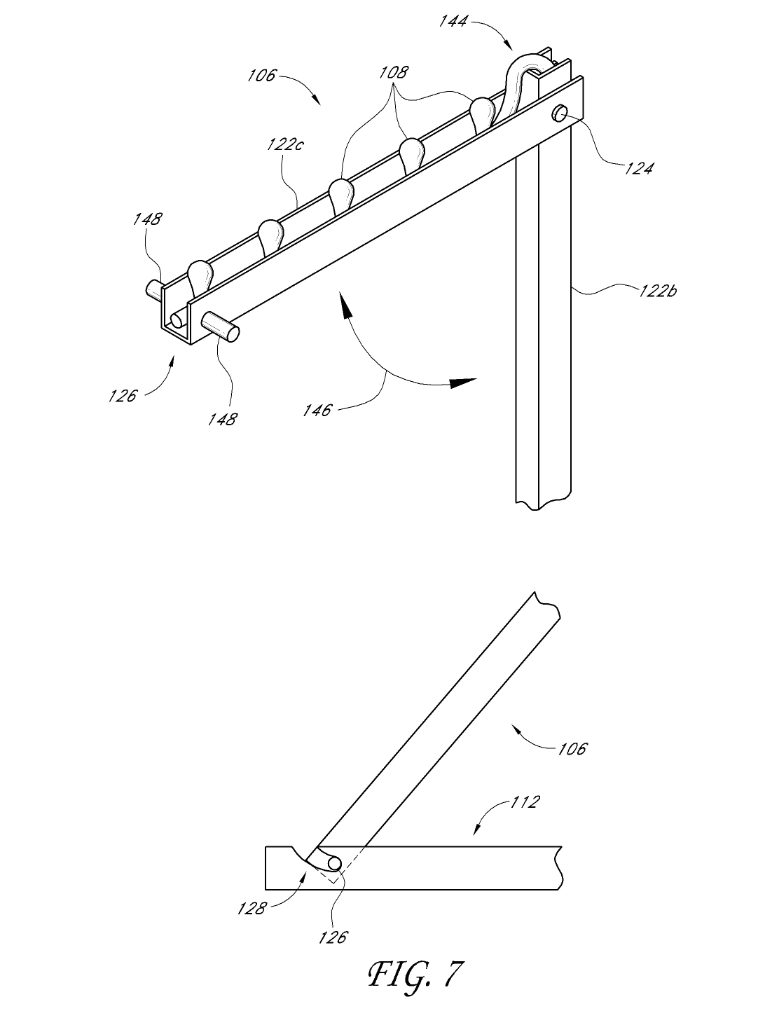

FIG. 7 illustrates an example of folding action of the segments 122a, 122b, 122c of the outer supports 106 that can be employed to transition between compacted and expanded states. A wire 144 extends through a U-shaped channel in the outer support 106 to provide electrical power to the lighting components 108. The joint 124 allows segments 122b, 122c of the outer support 104 to swivel with respect to each other as shown by the arrow 146. A lower end 126 of the outer support 106 can be provided with pegs 148, or other suitable structure for sliding within the hook-like structure 128 of the base support 112 to secure the outer supports 106 to the base support 112 in a removable manner. Many other structures and methods can be used to expand or contract the segments of the outer supports 106 and to secure the outer supports 104 to the base support 112.

FIG. 8 illustrates another version of a central support 104, which can be used in any of the embodiments disclosed herein. The central support 104 is comprised of central support segments 104a, 104b, 104c, which can be hollow, allowing an electrical wire 116 to pass through from an electrical connector 118 on a first end to another electrical connector 155 at a second end. In some embodiments, the wire can be curled or spring-like to readily expand or contract to permit the central support segments 104a, 104b, and 104c, and 150c to be disassembled and aligned in a substantially parallel manner for convenient storage without breaking, cutting, or crimping the electrical wire 116.

Each of the central support segments 104a, 104b, 104c can also include a male portion 154 at one end and a receiving portion 156 at the other end. The receiving portion 156 can have a wider cross-sectional area. The male portion 154 can be made to fit within a corresponding adjacent receiving portion 156 in a stable manner. A spring-loaded pushbutton 152 or other connection structure can be provided on the male portion 154 to fit within a corresponding bore (not shown in this figure) on a receiving portion 156 of an adjacent central support segment. When the male portion 154 is initially inserted into the receiving portion 156, the pushbutton 152 is temporarily depressed within the body of the central support segment. As the male portion 154 is advanced further within the receiving portion 156, the pushbutton extends outwardly upon contacting the bore in the receiving portion 156. This can secure the components together until the pushbutton is depressed into the bore and the segments of the central support are separated from each other. Once separated, the segments 104a, 104b, 104c of the central support 104 can be positioned so that their longitudinal axes are roughly aligned for convenient storage. Electrical connector 155 can be connected to the top portion 110, which in turn can be electrically connected to the lighting components 108.

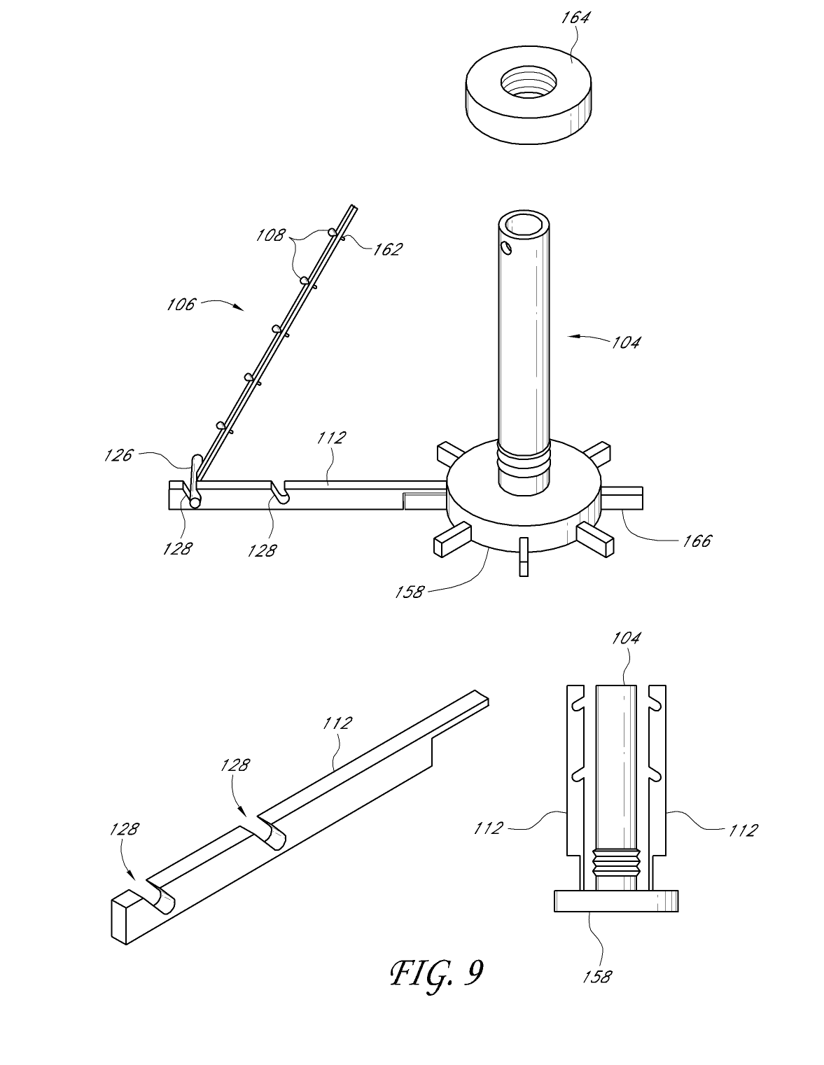

FIG. 9 illustrates an example of an embodiment of the base 102, including a hub 158 as illustrated in FIG. 3. In this configuration, as illustrated, the lighting components are connected to both an outer support 106 (comprised of a wire, string, or optical fiber, etc.) and an electrical power cord 160 by way of clips 162. On a bottom end, the outer support 106 and power cord 160 are connected to a rod 126 for securing to a hook-like structure 128 in the base support 112.

The base supports 112 can be connected to attachment components 166 on the hub 158 by any suitable connection, or formed as a unitary structure. In some embodiments, the base supports 112 can fold upwardly into a roughly parallel relationship with at least a portion of the central support 104. When the base supports 112 are positioned in a substantially flat arrangement in the assembled state, a ring 164 or other suitable structure can be passed over the central support 106 and rotated over threads adjacent to the hub 158 to help secure the base members 112 in the flat position during use. The ring 164 can be larger in cross-section than the hub 158 to stabilize the central support 104 and to keep the base members 112 substantially flat. An outer surface of the ring 164 can include a partially or entirely knurled finished or otherwise include surface roughenings to allow convenient turning during connection. The connection between the hub 158 and the central support 104 can be achieved by a hinge, snap, screw, or any other suitable means.

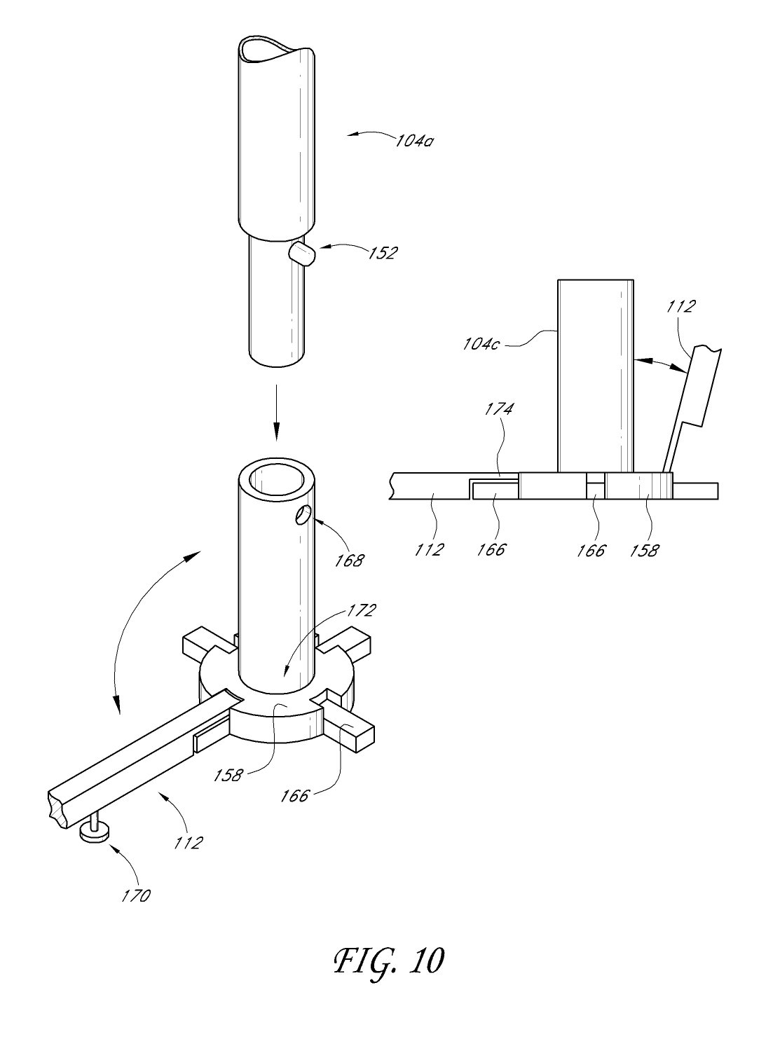

FIG. 10 illustrates an example of a segmented central support 104 as in FIG. 8 wherein one central support segment 172 is on a hub 158. The pushbutton 152 on central support segment 104a is depressed and then expands into the bore 168 on central support segment 172. The L-shape end 174 of the base support 112 can allow the base support 112 to be securely fastened to attachment component 166 with an appropriate hinge or fastener on the hub 158 when the Christmas tree 100 is in the assembled position. One or more levelers 170 on the base 102 can help achieve leveling of the tree 100, especially if the tree 100 will be used on an uneven surface.

FIG. 11 illustrates another embodiment of a Christmas tree 100 that is similar in many respects to the devices described elsewhere in this application. The components of the central support 104 are secured and released by means of substantially triangular-shaped spring-loaded levers 175, as in a telescoping umbrella. The top portion 110 can be retracted into the top most central support segment (104c, in FIG. 11) and/or a decoration 178 can be retracted into a chamber within the top portion 100, for convenient storage. The top portion 110 and/or decoration 178 can be released later and raised manually or raised with the assistance of a force spring 176. The decoration 178 may optionally comprise retractable arms 180 which can be rotated and/or folded close to each other as shown in FIG. 11 to facilitate the retraction of the decoration 178 into the top portion.

The examples shown in the drawings and described in the text of this application are not intended to be limiting, but merely to illustrate various aspects of certain embodiments of these inventions. Many other alternatives and configurations are possible, and are encompassed by this disclosure. Moreover, each of the components and features described herein with respect to each embodiment can be used in other embodiments of this disclosure to form additional embodiments not expressly illustrated or described. All distances, lengths, materials, and other exemplary features of these inventions are provided for purposes of illustration only.

What is claimed is:

1. A decorative artificial tree comprising:
a base, comprising a plurality of base supports radiating from a base hub, wherein the base is configured to be collapsible;
a central support;
a top portion; and
a plurality of outer supports, wherein at lease one outer support extends from at least one base support to the top portion.

2. The tree of claim 1, wherein at least one of the plurality of outer supports comprises a rigid material.

3. The tree of claim 2, wherein the rigid material is a plastic or a metal.

4. The tree of claim 1, wherein at least one of the outer supports emits light by conducting light from a light source external to the outer supports.

5. The tree of claim 1, further comprising a plurality of lighting components attached to at least one of the outer supports.

6. The tree of claim 5, wherein at least one of the outer supports comprises electrical wire and supplies electrical power to at least one of the lighting components.

7. The tree of claim 5, wherein the central support comprises an inner wall of the central support, and wherein the inner wall of the central support comprises a conductive material and supplies electrical power to at least one of the lighting components.

8. The tree of claim 1, wherein the central support is configured to be collapsible.

9. The tree of claim 1, wherein the central support comprises a plurality of segments.

10. The tree of claim 8, wherein the central support is configured to be collapsed by actuating a spring-loaded button or lever.

11. The tree of claim 9, wherein the central support is configured to be collapsed by partially or fully nesting at least one segment within another segment.

12. The tree of claim 1, wherein the base is configured to be collapsed by detaching at least one base support from the base hub.

13. The tree of claim 1, wherein at least one base support is configured to be collapsible.

14. The tree of claim 1, wherein at least one base support is a segmented base support comprising a plurality of segments.

15. The tree of claim 14, wherein the segmented base support is configured to be collapsed by folding at least one segment relative to another segment.

16. The tree of claim 1, wherein at least one base support can be partially or fully folded up against the central support.

17. The tree of claim 1, wherein at least one outer support is configured to be collapsible.

18. The tree of claim 1, wherein at least one outer support is a segmented outer support comprising a plurality of segments.

19. The tree of claim 18, wherein the segmented outer support is configured to be collapsed by folding at least one segment relative to another segment.

20. The tree of claim 1, wherein the tree is configured to be collapsed by detaching at least one outer support from at least one base support.

21. The tree of claim 1, further comprising a top decoration attached to the top portion, wherein the tree is configured to be collapsed by fully or partially retracting the top decoration into the top portion.
